(19) United States
(12) Patent Application Publication
(10) Pub. No.: US 2006/0098733 A1
(43) Pub. Date: May 11, 2006

(54) Variable-length coding device and method of the same

(75) Inventors: Atsushi Matsumura, Kanagawa (JP); Takeshi Chujoh, Kanagawa (JP); Shinichiro Koto, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/268,721

(22) Filed: Nov. 8, 2005

(30) Foreign Application Priority Data
Nov. 8, 2004 (JP) 2004-324211

(51) Int. Cl. H04N 11/04; H04N 7/12; H04B 1/66; H04N 11/02

(52) U.S. Cl. 375/240.03; 375/240.23; 375/240.18; 375/240.12

(57) ABSTRACT

It is an object to improve coding efficiency by suitably setting, with respect to input information in moving image coding, a parameter for quantization calculation at the time of quantization. Various parameters for quantization calculation are set by a parameter setter 103, quantization is performed with the set parameters for quantization calculation by a quantizer 102, a coding cost J is calculated from a generated code amount R and a quantization distortion amount R obtained as a result thereof, and a parameter judgment unit 107 for quantization calculation selects, as a parameter for quantization calculation having highest coding efficiency, a parameter by which the coding cost J becomes minimum.

### CROSS-REFERENCE TO RELATED APPLICATIONS

This application is based upon and claims the benefit of priority from the prior Japanese Patent Application No. 2004-324211, filed on 8 Nov. 2004; the entire contents of which are incorporated herein by reference.

### TECHNICAL FIELD

The present invention relates to a variable-length coding device for realizing variable-length coding of a high quality moving image.

### BACKGROUND OF THE INVENTION

As a moving image coding technique, an MPEG (Moving Picture Experts Group) system has been put to practical use. The MPEG system is based on motion compensative prediction, orthogonal transformation and variable-length coding. A residual signal relative to an original image is acquired by the motion compensative prediction, and the residual signal is orthogonally transformed to obtain a transformation coefficient. The transformation coefficient is quantized by a quantization scale corresponding to a target bit rate, and the transformation coefficient after the quantization is variable-length coded.

Although the MPEG system is standardized by ISO/IEC (H.26X system is standardized by ITU-T), at this time, articles determined as the standard are only the decoding system, and the coding system is not determined. That is, a motion vector detection method for the motion compensative prediction and a quantization method can be uniquely processed by a coder.

For example, an inverse quantization processing (residual signal 4×4) in MPEG-4AVC/H.264 (hereinafter referred to as H.264) jointly determined by ISO/IEC and ITU-T is as follows.
d′ᵢⱼ=((cᵢⱼ*LevelScale(qP %6, i, j))<<(qP/6) [Mathematical expression 1]
Where, i,j denote coordinates in a block, d′ᵢⱼ denotes a coefficient after inverse quantization, and cᵢⱼ denotes a coefficient obtained after variable-length decoding is performed. Besides, qP denotes a quantization parameter, and LevelScale denotes a scale adjustment parameter for integer orthogonal transformation in H.264 and is a matrix value indicated below.

$$Level Scale ( m , i , j ) = \{ \begin{matrix}{v}_{m 0} \text{:} for ( i , j ) ∈ \{ ( 0 , 0 ) , ( 0 , 2 ) , ( 2 , 0 ) , ( 2 , 2 ) \} \\ {v}_{m 1} \text{:} for ( i , j ) ∈ \{ ( 1 , 1 ) , ( 1 , 3 ) , ( 3 , 1 ) , ( 3 , 3 ) \} \\ {v}_{m 2} \text{:} otherwise\end{matrix} \}$$

$${v}_{ij} = [ \begin{matrix}10 & 16 & 13 \\ 11 & 18 & 14 \\ 13 & 20 & 16 \\ 14 & 23 & 18 \\ 16 & 25 & 20 \\ 18 & 29 & 23\end{matrix} ]$$

From the mathematical expression 1, an expression of quantization is generally derived as indicated below.
cᵢⱼ=Sign(dᵢⱼ)*((Abs(dᵢⱼ)*LevelScale2(qP %6, i, j)+offset))>>(15+qP/6) [Mathematical expression 2]
Where, dᵢⱼ denotes an integer orthogonal transformation coefficient, and cᵢⱼ denotes a coefficient to be variable-length coded. Besides, LevelScale2 is a scale adjustment parameter for integer orthogonal transformation in H.2.64, and is a matrix value indicated below.

$$Level Scale 2 ( m , i , j ) = \{ \begin{matrix}{w}_{m 0} \text{:} for ( i , j ) ∈ \{ ( 0 , 0 ) , ( 0 , 2 ) , ( 2 , 0 ) , ( 2 , 2 ) \} \\ {w}_{m 1} \text{:} for ( i , j ) ∈ \{ ( 1 , 1 ) , ( 1 , 3 ) , ( 3 , 1 ) , ( 3 , 3 ) \} \\ {w}_{m 2} \text{:} otherwise\end{matrix} \}$$

$${w}_{ij} = [ \begin{matrix}13107 & 5243 & 8066 \\ 11916 & 4660 & 7490 \\ 10082 & 4194 & 6554 \\ 9362 & 3647 & 5825 \\ 8192 & 3355 & 5243 \\ 7282 & 2893 & 4559\end{matrix} ]$$

Besides, offset denotes a rounding parameter, and in H.264, it is recommended that the value of the offset is set so that the a rounding operation is performed by ⅓ in an intra-frame prediction block and ⅙ in an inter-frame prediction block. In general, although the rounding operation is often performed with ½, since the distribution of the integer orthogonal transformation coefficient resembles the Laplace distribution, and the broadening of the Laplace distribution of the coefficient of the inter-frame prediction block is narrower and steeper than that of the intra-frame prediction block, the above value is empirically set. However, the integer orthogonal transformation coefficient is not necessarily approximated to the Laplace distribution in sequence units or macro block units, and it is difficult to uniquely determine the offset.

On the other hand, in non-patent document 1 (“IMPROVEMENT OF PICTURE QUANTITY OF AVC BY QUANTIZATION WITH FREQUENCY DEPENDENT DEAD ZONE”, 2004, general conference of The Institute of Electronics, Information and Communication Engineers), a method is proposed in which among high components of frequency, a coefficient with small power is truncated, so that a generated code amount is suppressed, and a lower component coefficient can be finely quantized. However, there is a problem that when the above processing is simply applied to the whole sequence, an image becomes such that the resolution is low and a blur is included, and whether the above processing should be applied has to be adaptively controlled in macro block units.

As described above, there are various parameters for controlling the quantization, and the combination of them is wide-ranging. When an optimum parameter for quantization calculation can be adaptively determined among them, the reduction of quantization distortion and the suppression of code generation can be realized, and coding efficiency can be improved.

Then, the present invention has been made in view of the above, and has an object to provide a variable-length coding device which can raise the coding efficiency by adaptively setting a parameter suitable for a quantizer, and a method of the same.

### BRIEF SUMMARY OF THE INVENTION

According to embodiments of the present invention, a variable-length coding device includes a quantization processor to obtain quantization information by quantizing inputted input information, a parameter setting processor to set a single or plural kinds of parameters for quantization calculation used when the quantization is performed, a code amount calculation processor to calculate a generated code amount generated when the quantization information is variable-length coded, a quantization distortion calculation processor to calculate a quantization distortion amount of the quantization information, a cost calculation processor to calculate a coding cost from the quantization distortion amount and the generated code amount, a parameter search processor which controls the parameter setting processor to change the parameter for quantization calculation to be set, calculates coding costs by the cost calculation processor for the respective changed parameters for quantization calculation, and selects a parameter for quantization calculation corresponding to the minimum coding cost among the calculated coding costs, and a variable-length coding processor to variable-length code the quantization information quantized by using the selected parameter for quantization calculation.

According to embodiments of the present invention, the parameter for quantization calculation to improve the coding efficiency can be adaptively set.

### BRIEF DESCRIPTION OF THE DRAWINGS

FIG. 1 is a processing flow of a moving image coding device according to an embodiment of the invention.

FIG. 2 is a view showing a structure of a quantization processing of the moving image coding device according to the embodiment of the invention.

FIG. 3 is a view showing a structure of a quantization processing of a moving image coding device according to a first embodiment of the invention.

FIG. 4 is a view showing a structure of a quantization processing of a moving image coding device according to a second embodiment of the invention.

FIG. 5 is a view for explaining quantization with a dead zone.

FIG. 6 is a view for explaining quantization with a dead zone (rounding offset).

FIG. 7 is a view for explaining quantization with a dead zone (dead-zone offset).

FIG. 8 is a view for explaining isolated point removal quantization.

FIG. 9 is a view for explaining an offset to change a first quantization step to a second quantization step.

### DETAILED DESCRIPTION OF THE INVENTION

Hereinafter, embodiments of a moving image coding device of the invention will be described with reference to the drawings.

### First Embodiment

(1) Processing Content of Moving Image Coding Device

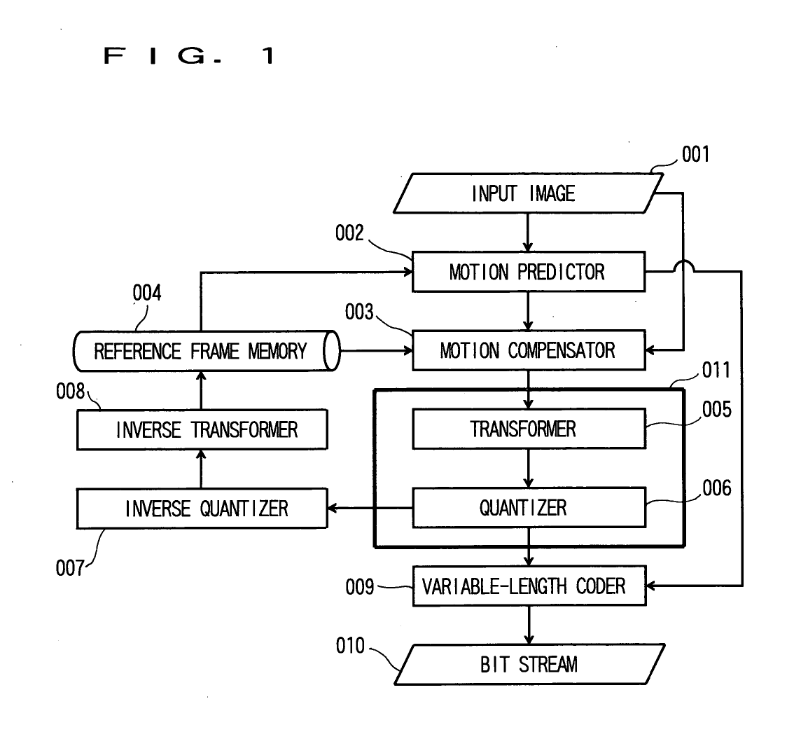

FIG. 1 is a view schematically showing a processing flow of a moving image coding device according to a first embodiment of the invention. This moving image coding device adopts, for example, H.264. Incidentally, also in MPEG-1/2/4 and H.261/262/263 standardized by ISO or ITU-T, the coding processing is performed by a similar processing flow.

An input image 001 is inputted to a motion predictor 002 and a motion compensator 003.

In the motion predictor 002, motion vector detection is performed, and in the motion compensator 003, motion compensation is performed from the detected motion vector, and a residual signal relative to the input image is obtained.

The residual signal is transformed by a transformer 005, and is then quantized by a quantizer 006. This quantization processing will be described later in detail.

A transformation coefficient after the quantization and the motion vector detected by the motion predictor 002 are inputted to a variable-length coder 009, are variable-length coded, and are outputted as a bit stream 010.

The transformation coefficient after the quantization is inversely quantized by an inverse quantizer 007 and is inversely transformed by an inverse transformer 008 in order to form a reference frame required by the motion predictor 002 and the motion compensator 003. A decoded image is re-constructed from an obtained decoded residual signal, is stored in a reference frame memory 004, and is used in the motion predictor 002 and the motion compensator 003.

(2) Quantization Processing

A portion including the transformer 005 and the quantizer 006 and indicated by a block 011 in FIG. 1 is extracted and the detailed processing content will be described.

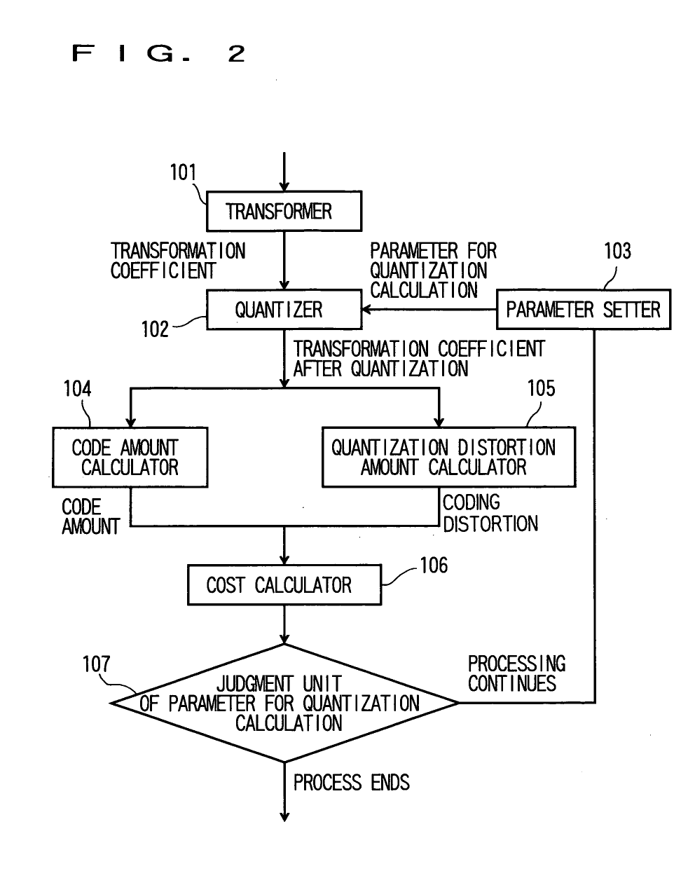

FIG. 2 is a view showing a quantization processing in the moving image coding device according to this embodiment.

The residual signal from the motion compensator 003 is inputted to a transformer 101 and is transformed, and the transformation coefficient is obtained. As this transformation, in the case of H.264, an integer type discrete cosine transformation is named.

The transformation coefficient is inputted to a quantizer 102 and is quantized. As this quantization method, the technique described in the background of the invention section is used.

A parameter for quantization calculation to determine the quantization processing is set by a parameter setter 103. The parameter for quantization calculation set by the parameter setter 103 will be described below. Incidentally, the parameter for quantization calculation is a term different from the quantization parameter as a general technical term.

(2-1) Parameter for Quantization Calculation

As the parameter for quantization calculation, for example, a rounding offset, a dead zone offset, a parameter for quantization calculation relating to an isolated point, and the like, which are described below, can be named.

(2-1-1) Rounding Offset

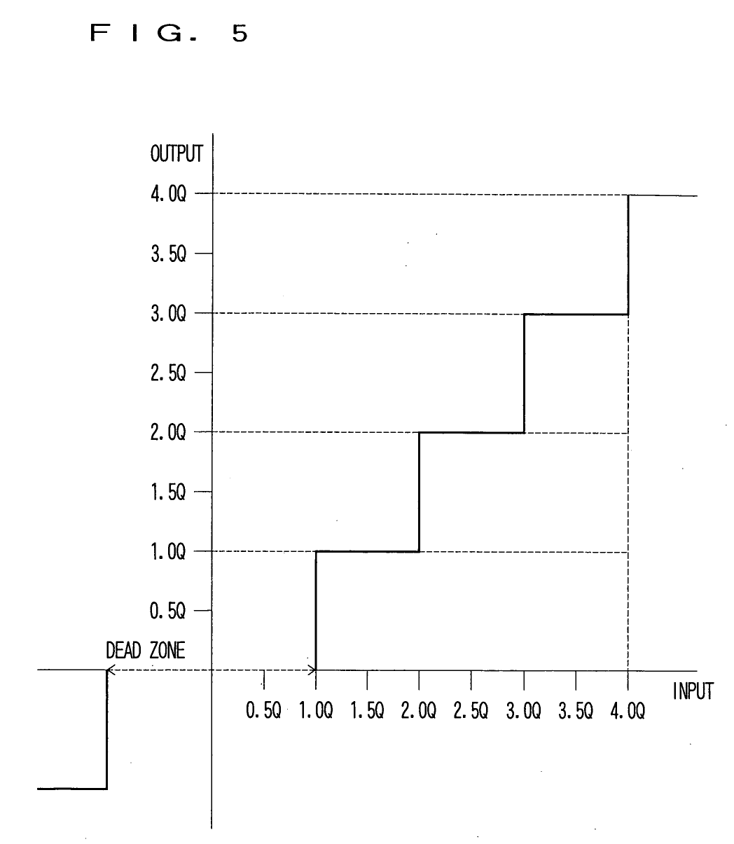

In this embodiment, since H.264 is adopted, the quantization with dead zone using the expression indicated by the mathematical expression 2 is generally performed in the quantizer 102. The quantization with dead zone is a quantization method having a zone in which as shown in FIG. 5, even if the input signal is not zero, the output value becomes zero by the quantization.

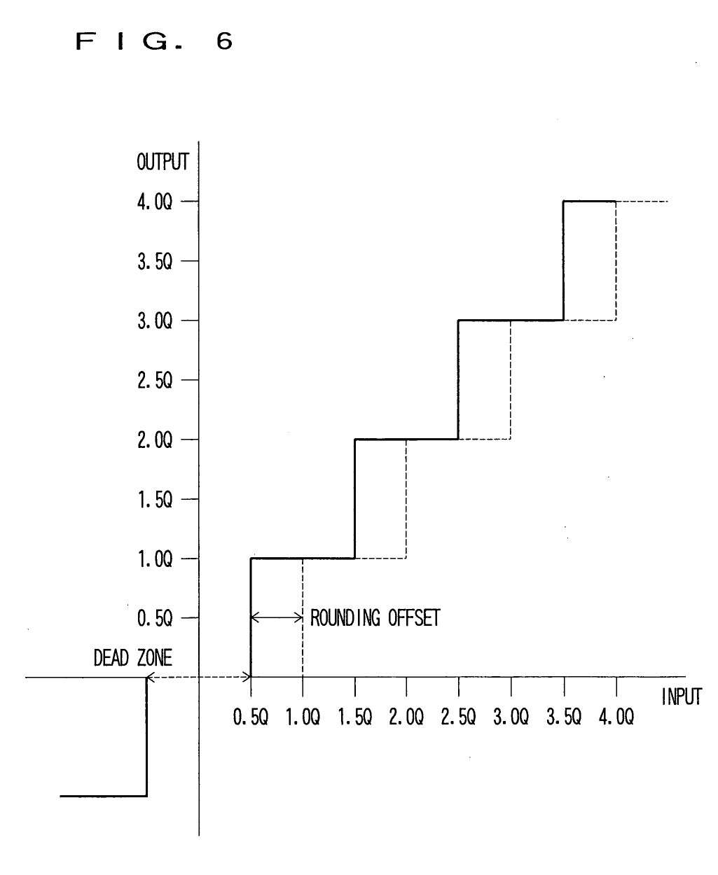

However, in general, truncation is not necessarily equal to the dead zone as shown in FIG. 5, and as shown in FIG. 6, a parameter for performing a rounding operation is set as a rounding offset. The offset in the mathematical expression 2 corresponds to this rounding offset. In a general H.264 coding device, the rounding offset is set to be constant (⅓ in the intra-prediction macro block, and ⅙ in the inter-prediction macro block). However, in this embodiment, the rounding offset is adaptively changed and set as the parameter for quantization calculation by the parameter setter 103. This setting method will be described later.

(2-1-2) Dead Zone Offset

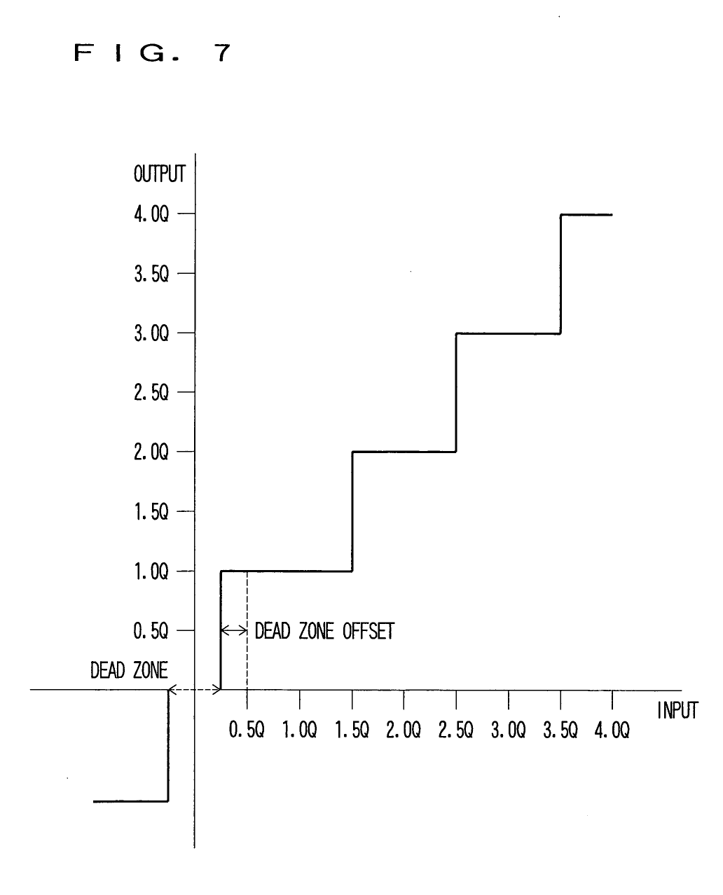

Further, as shown in FIG. 7, a dead zone offset is prepared as a parameter for quantization calculation to adaptively set only the range of the dead zone as shown in FIG. 7, and is set by the parameter setter 103. This setting method will be described in the following.
cᵢⱼ=Sign(dᵢⱼ)*((Abs(dᵢⱼ)*LevelScale2(qP %6, i, j)+offset))>>(15+qP/6)
if(cᵢⱼ=0)
cᵢⱼ=Sign(dᵢⱼ)*((Abs(dᵢⱼ)*LevelScale2(qP %6, i, j)+deadzoneoffset))>>(15+qP/6) [Mathematical expression 3]

A difference from the rounding offset is that as indicated by the mathematical expression 3, only in the case where quantization was made to zero as a result of normal quantization, the dead zone off set is set to again perform the quantization processing, and what was quantized to zero in the offset is again picked up. This is a processing for holding a broad component of a frequency with small power. Accordingly, it becomes possible to hold a grain noise which is important information in image properties although its power is small.

(2-1-3) Parameter for Quantization Calculation Relating to Isolated Point

When the dead zone offset is introduced, there often occurs a case where a coefficient after the quantization does not become zero in a high component.

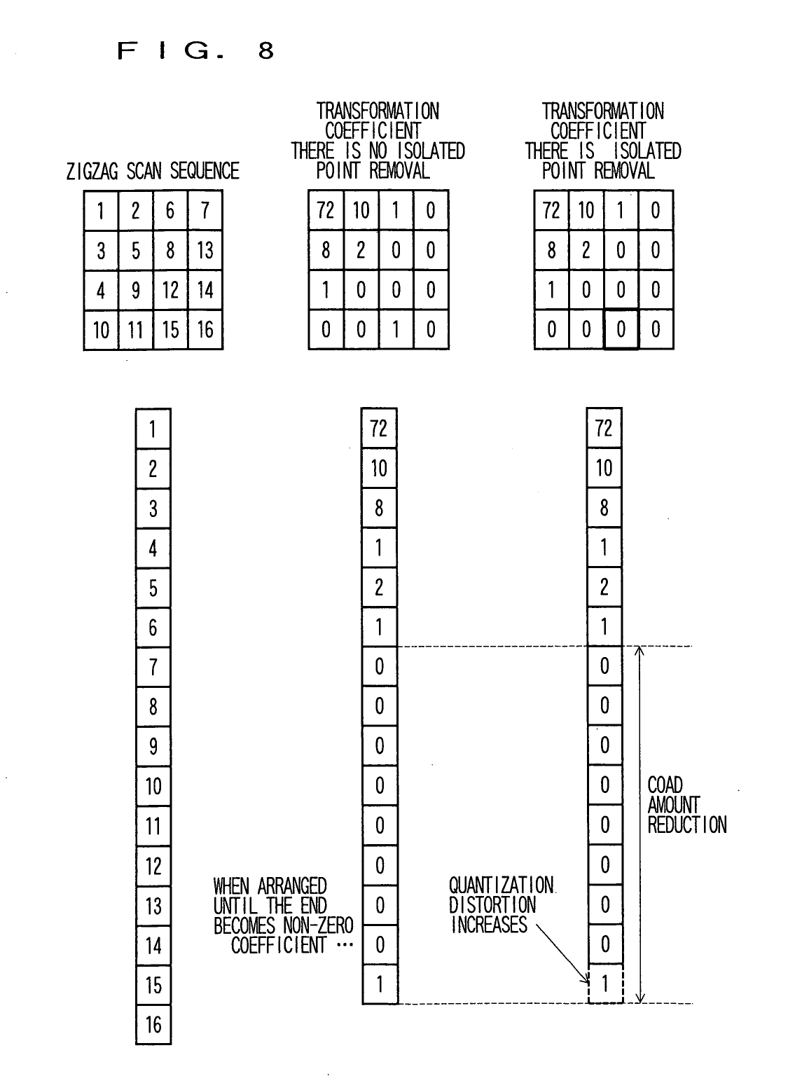

For example, in a 4×4 block (zigzag scan) as shown in the left drawing of FIG. 8, with respect to the transformation coefficients after the quantization, there easily occurs such a state that a nonzero coefficient (hereinafter referred to as an isolated point) exists at only one point after zero coefficients are continuous as shown in FIG. 8 (center drawing) Since the variable-length coding is performed after the transformation coefficients are arranged to the final nonzero coefficient in the order of zigzag scanning, even if the same nonzero coefficient is coded, the generated code amount is significantly changed according to whether it is the isolated point or not.

Then, as shown in the right drawing of FIG. 8, when the isolated point is quantized to zero (hereinafter referred to as isolated point removal), the generated code amount can be greatly reduced. Especially, in the case where the dead zone offset is introduced, since the isolated point is liable to occur, it is important to remove the isolated point, and this greatly contributes to the improvement of the coding efficiency.

However, since quantization distortion naturally occurs, the isolated point can not be simply removed. Especially, in the case where the number of continuous zeros is 1 or 2, or the value of the coefficient of the isolated point is a large value, the reduction effect of the generated code amount is low, a quantization error is also increased, and the coding efficiency is lowered by contrary. Then, the number (distance) of zeros existing before a judgment of an isolated point is made, and a threshold according to which the coefficient regarded as the isolated point is quantized to zero are set by the parameter setter 103 adaptively as the parameter for quantization calculation. This setting method will be described later.

(2-1-4) Offset to Change First Quantization Step to Second Quantization Step

As the parameter for quantization calculation, an offset to change a first quantization step to a second quantization step can be set. Here, it is assumed that a step width of the second quantization step is larger than a step width of the first quantization step.

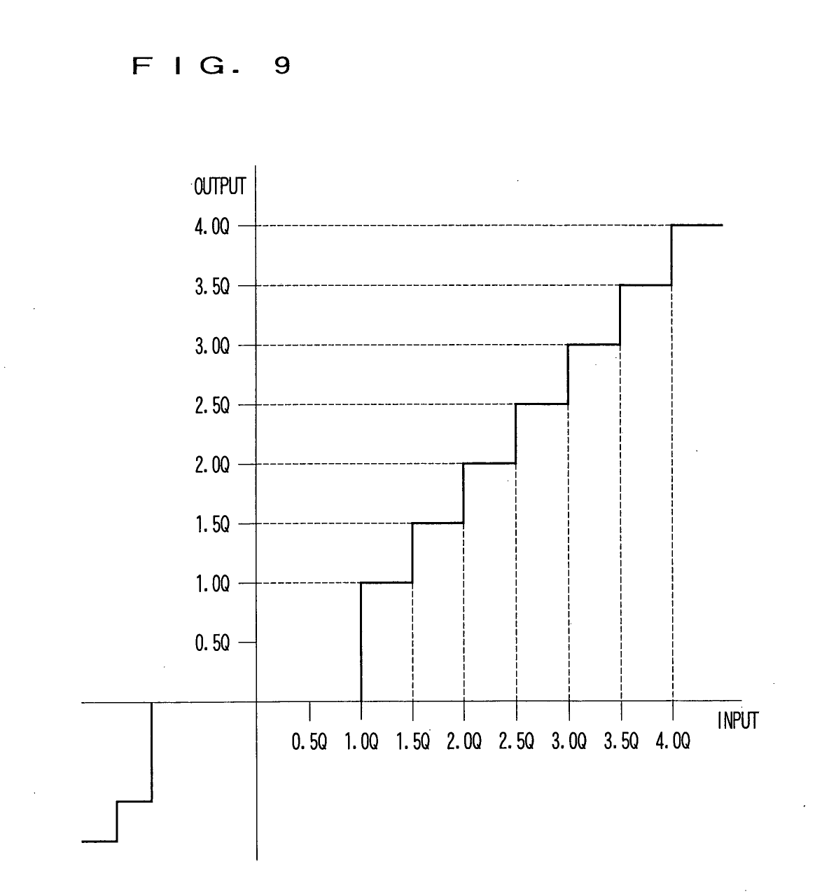

As shown in FIG. 9, when the step width of the first quantization step is, for example, 0.5 Q, and the step width of the second quantization step is 1.0 Q, in the case where quantization to zero is performed by the quantization at the second quantization step, quantization to zero is performed. On the other hand, in the case where quantization to nonzero is performed, quantization is performed by the first quantization step.

In this case, the parameter for quantization calculation is made 0.5 Q as a difference (offset) between the step width of the first quantization step and the step width of the second quantization step.

By this, among high components of the frequency, a coefficient with small power is truncated, so that the generated code amount is suppressed and a lower component coefficient can be finely quantized.

(2-1-5) Optimization of Value of Scaling List

Especially, according to H.264 in this embodiment, a value of a scaling list can also be optimized as a parameter for quantization calculation. In general, since a default scaling list is used, and this is data stored in the inside of a decoder, there is no overhead to code a coefficient of the scaling list.

However, even if there is an overhead to code the coefficient of the scaling list instead of the default, there is also a case where the coding efficiency can be more raised. In this embodiment, since parameters for quantization calculation to improve the coding efficiency, which include the overhead to code the coefficient of the scaling list, can be set, the coding efficiency can be improved by using the original scaling list instead of the default scaling list.

(2-1-6) Others

Further, as a unique standard, for example, in the case where the rounding offset is also coded, it is possible to set a parameter for quantization calculation which is high in coding efficiency including a generated code amount required therefor.

(2-2) Setting Method of Parameter for Quantization Calculation

As described above, the various parameters for quantization calculation are set by the parameter setter 103, so that the quantization control having high degree of freedom becomes possible. However, it is not known that setting of which parameter for quantization calculation can contribute to the coding efficiency (that is, coding cost), and the setting can not be easily performed. Then, in this embodiment, rate distortion optimization based on the Lagrange's method of undetermined multipliers is used, and the parameter for quantization calculation is set.

When a generated code amount is R, a quantization distortion amount is D, and a Lagrangian multiplier dependent on a quantization scale is λ, a parameter for quantization calculation to minimize a Lagrange cost J indicated by
J=D+λR [Mathematical expression 4]
is set as a parameter by which the coding efficiency is highest.

That is, from respective generated code amounts R and quantization distortion amounts D, obtained as a result of processings using various parameters for quantization calculation, the parameter for quantization calculation by which the Lagrange cost J becomes minimum is determined to be the parameter by which the coding efficiency is highest.

The Lagrange cost J necessary for realizing the above is calculated from the linear sum expression of the mathematical expression 4 by the cost calculator 106 from the results of calculation of the generated code amount R by a code amount calculator 104 and calculation of the quantization distortion amount D by a quantization distortion calculator 105. Incidentally, the details of the code amount calculator 104 and the quantization distortion calculator 105 will be described later.

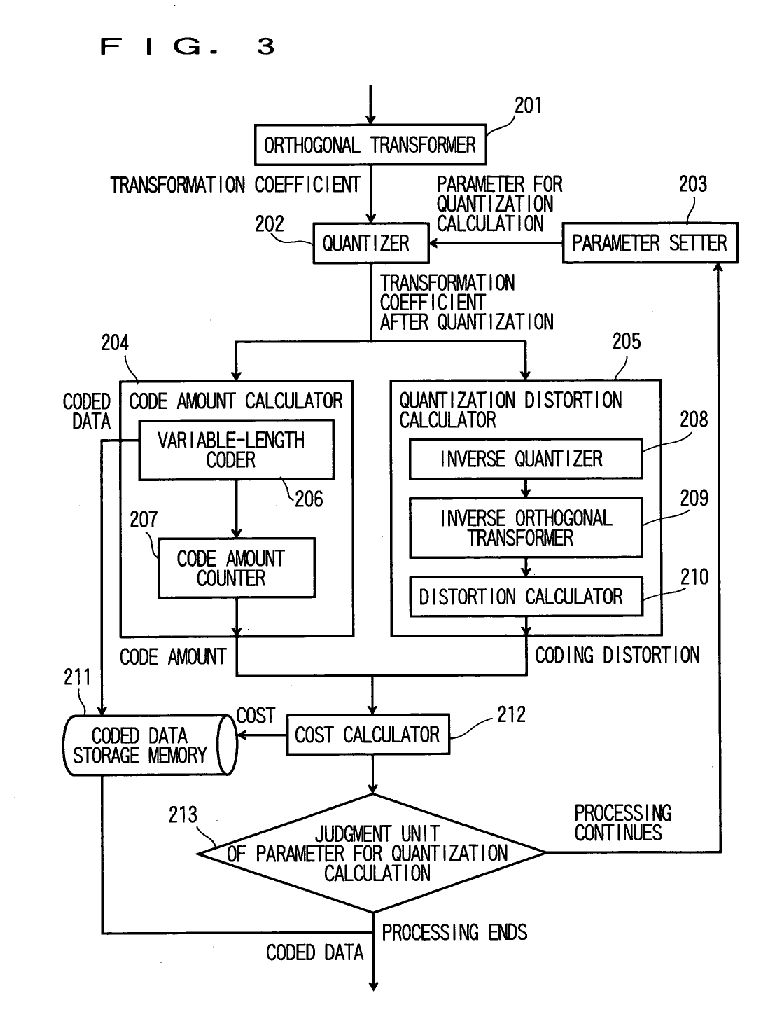

In the cost calculator 106, the obtained Lagrange coding cost J and the coding data obtained from the quantizer 102 are inputted to a coding data storage memory 211_(see FIG. 3) storing the minimum Lagrange cost J at the present time point and the coding result at that time. Then, a comparison operation between the minimum Lagrange cost J at the present time point and the now obtained Lagrange cost J is performed, and the Lagrange cost J with a smaller value and the coding result at that time are stored.

(2-3) Role of Judgment Unit 107 of Parameter for Quantization Calculation

A judgment unit 107 of parameter for quantization calculation judges whether or not the parameter setter 103 is allowed to set a new parameter for quantization calculation. In the case where the setting is allowed, the processing proceeds to the parameter setter 103, the new parameter for quantization calculation is set in the quantizer 102 to perform the quantization, and the Lagrange cost J is finally calculated and compared. In the case where the setting is not allowed, the loop processing of the quantization is ended, and advance is made to a next processing.

That is, the judgment unit 107 of parameter for quantization calculation performs the loop processing as indicated by the flowchart of FIG. 2. First, the parameter for quantization calculation as the initial value is set by the parameter setter 103, and the transformation coefficient is quantized by the quantizer 102 using the parameter for quantization calculation. Next, the generated code amount R is obtained by the code amount calculator 104 from the quantized transformation coefficient, and the quantization distortion amount D is obtained by the quantization distortion calculator 105. The Lagrange cost J as the coding cost is calculated by the cost calculator 106, and the Lagrange cost J with a low coding cost and the coding result at that time are stored in the coding data storage memory 211. The judgment unit 107 of parameter for quantization calculation controls the parameter setter 103 so that the setting of the parameter for quantization calculation is changed in sequence, and the Lagrange cost J is calculated in sequence for each parameter for quantization calculation. The parameter for quantization calculation having the lowest Lagrange cost J in the loop processing performed a predetermined number of times is made the optimum parameter for quantization calculation. That is, the Lagrange cost J having the low coding cost and the coding result at that time are stored in the coding data storage memory 211. The number of times this loop processing is performed, that is, the number of the set parameters for quantization calculation may be previously determined, or may be delimited by time.

The unit of the loop processing of this quantization may be a macro block unit, a coefficient unit, a frame unit or a sequence unit. When the loop of the quantization is performed in the macro block unit, since the parameter for quantization calculation can be optimized more finely, as compared with the case where it is performed in the sequence unit, the improvement of the coding efficiency is expected.

Incidentally, the loop processing may be performed with one kind of parameter for quantization calculation in those described above, or the loop processing may be performed with the plural kinds of parameters for quantization calculation at once. When the parameters for quantization calculation dependent on each other are processed at once, the coding cost becomes low.

In the case where the loop processing of the quantization is ended and an advance is made to a next processing, the coded data stored in the coded data storage memory 211 (see FIG. 3) is outputted as the actually coded data. There is also a case where the coded data at this time includes not only the quantized coefficient but also the parameter for quantization calculation used for the quantization.

(2-4) Processing of the Code Amount Calculator 104 and the Quantization Distortion Calculator 105

The detailed processing of the code amount calculator 104 and the quantization distortion calculator 105 will be described with reference to FIG. 3, and the calculation method of the generated code amount R and the quantization distortion amount D will be described.

(2-4-1) Processing of the Code Amount Calculator 104

A block 204 shown in FIG. 3 is the code amount calculator 104 of FIG. 2 and includes therein a variable-length coder 206 and a generated code amount counter 207.

A transformation coefficient quantized by a quantizer 202 in accordance with a parameter for quantization calculation set by a parameter setter 203 is inputted to the variable-length coder 206, and the coding processing is actually performed.

A bit stream obtained as a result of the coding by the variable-length coder 206 is inputted to the generated code amount counter 207, and the accurate generated code amount R is counted.

The counted generated code amount R is inputted to a cost calculator 212, and is used as a value to calculate the Lagrange cost J.

(2-4-2) Processing of the Quantization Distortion Calculator

A block 205 shown in FIG. 3 is the quantization distortion calculator 105 in FIG. 2, and includes therein an inverse quantizer 208, an inverse transformer 209 and a distortion calculator 210.

The transformation coefficient quantized by the quantizer 202 in accordance with the parameter for quantization calculation set by the parameter setter 203 is inputted to the inverse quantizer 208, an inverse quantization processing is performed, and the result is inputted to the inverse transformer 209.

A decoded residual signal obtained by the inverse transformation performed by the inverse transformer 209 is inputted to the distortion calculator 210.

The distortion calculator 210 calculates the square sum of a difference between the residual signal before the coding and the residual signal after the decoding, and calculates the accurate quantization distortion amount D. The calculated quantization distortion amount D is inputted to the cost calculator 212, and is used as a value to calculate the Lagrange cost J.

(2-4-3) Conclusion

As stated above, although the coding cost is required, the optimum parameter for quantization calculation can be set by calculating the accurate generated code amount R and the quantization distortion amount D.

Incidentally, in this embodiment, the variable-length coder 206 is provided in the inside of the code amount calculator 204, the coding is once performed there, and the data is stored in the coded data storage memory 211. By this, the wasteful processing of again performing the coding with the determined parameter for quantization calculation can be omitted by outputting the coding result with the parameter for quantization calculation finally determined by the judgment unit 107 of parameter for quantization calculation. That is, the processing by the variable-length coder 009 in FIG. 1 is reduced.

### Second Embodiment

A second embodiment relating to a calculation method for the generated code amount R and the quantization distortion amount D is a method in which a calculating cost for coding is reduced.

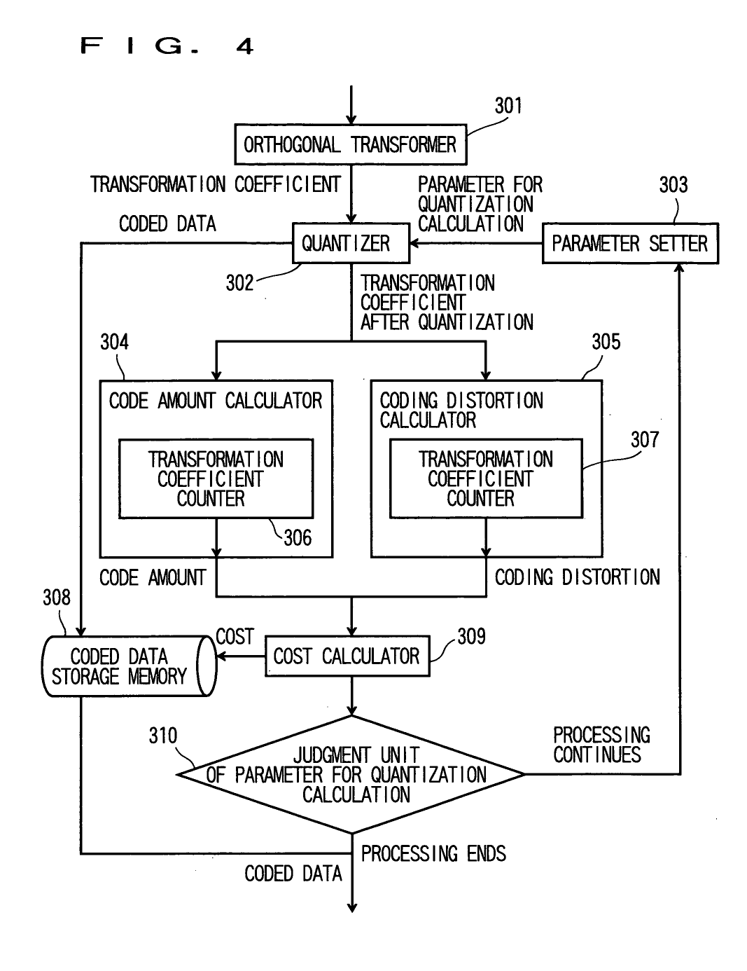

A block 304 shown in FIG. 4 is the code amount calculator 104 in FIG. 2, and a block 305 shown in FIG. 4 is the quantization distortion amount calculator 105 in FIG. 2.

Since the calculating cost is increased when the generated code amount R and the quantization distortion amount D are accurately calculated, with respect to the generated code amount, in this embodiment, a method disclosed in Japanese Patent Application No. 2004-96763 is adopted in which rate distortion optimization based on the Lagrange s method of undetermined multipliers is realized at low calculating cost.

A transformation coefficient counter 306 is provided in the inside of the code amount calculator 304, and counts a value of a nonzero coefficient of the transformation coefficients after the quantization to estimate the generated code amount. Further, a quantization error counter 307 is provided in the inside of the quantization distortion amount calculator 305, and counts a surplus at the quantization to estimate the quantization distortion amount. From these, the reduction of the calculating cost is realized.

As compared with the calculation of the generated code amount in the first embodiment, since the variable-length coding processing is not required, the calculating cost is low. Besides, as compared with the calculation of the quantization distortion amount in the first embodiment, since the inverse quantization and the inverse transformation processing are not required, the calculating cost is low.

Incidentally, in this embodiment, differently from the first embodiment, since the code amount calculator 304 does not include the variable-length coder, the processing in the variable-length coder 009 in FIG. 1 can not be reduced. However, the coding data quantized by a quantizer 302 is stored in a coding data storage memory 308, so that it is not necessary to again perform the quantization processing with the parameter for quantization calculation finally determined by a judgment unit 310 of parameter for quantization calculation, and the coded data can be inputted to the variable-length coder 009 in FIG. 1, and therefore, the processing amount of the quantizer 302 can be reduced.

### Modified Example

The invention is not limited to the above embodiments, but may be variously modified within the scope of its gist. Besides, various modifications or improvements can be added to the above embodiments.

For example, although H.264 is adopted in the embodiments, not to mention moving images of MPEG-1/2/4, even in the case where JPEG or JPEG2000 of still images is used, a similar effect can be obtained. The invention is not limited to H.264, but can be applied to systems of sound and others in addition to systems of only images, that is, all systems requiring quantization.

Besides, the description has been made especially with respect to the residual signal 4×4 in the quantization of H.264, the invention can be similarly applied to DC color difference 2×2, DC brightness 4×4, or residual signal 8×8.

What is claimed is:

1. A variable-length coding device comprising:
a quantization processor to obtain quantization information by quantizing input information;
a parameter setting processor to set a single or plural kinds of parameters to quante the input information;
a code amount calculation processor to calculate a code amount;
a quantization distortion calculation processor to calculate a quantization distortion amount of the quantization information;
a cost calculation processor to calculate a coding cost from the quantization distortion amount and the generated code amount;
a parameter search processor which controls the parameter setting processor to change the parameter for quantization calculation to be set, calculates coding costs by the cost calculation processor for the respective changed parameters for quantization calculation, and selects a parameter for quantization calculation corresponding to a minimum coding cost among the calculated coding costs; and
a variable-length coding processor to variable-length code the quantization information quantized by using the selected parameter for quantization calculation.

2. The variable-length coding device according to claim 1, wherein the cost calculation processor calculates the coding cost by a linear sum of the quantization distortion amount and the generated code amount.

3. The variable-length coding device according to claim 1, wherein the quantization distortion amount calculation processor calculates inverse quantization information by inversely quantizing the quantization information, and calculates the quantization distortion amount from a difference between the inverse quantization information and the input information before the quantization.

4. The variable-length coding device according to claim 1, wherein the input information is a transformation coefficient transformed by a transformation processor, and
the quantization distortion amount calculation processor
calculates inverse quantization information by inversely transforming the quantization information,
calculates inverse transformation information by inversely transforming the inverse quantization information, and
calculates the quantization distortion amount from a difference between the inverse transformation information and the input information before the transformation.

5. The variable-length coding device according to claim 1, wherein the code amount calculation processor variable-length codes the quantization information, the parameter for quantization calculation, or both of them, counts a code amount generated when the variable-length coding is performed, and calculates the generated code amount.

6. The variable-length coding device according to claim 1, wherein the parameter for quantization calculation is a threshold for selection as to whether the input information is quantized to a first quantization typical point or to a second quantization typical point.

7. The variable-length coding device according to claim 6, wherein in a case where the first quantization typical point is zero, the threshold is set so that the quantization to the second quantization typical point is likely to be performed.

8. The variable-length coding device according to claim 1, wherein
the input information is arranged in sequence based on a specified rule,
the parameter for quantization calculation is a threshold to judge as to whether a certain piece of input information positioned at a certain sequence in the input information arranged in sequence is made an isolated point, and
the quantization processor quantizes the input information, which was judged to be the isolated point according to the threshold, to zero.

9. The variable-length coding device according to claim 1, wherein the parameter for quantization calculation is an offset to change a step width of a first quantization step to a step width of a second quantization step, where the step width of the second step quantization is larger than the step width of the first quantization step, and
the quantization processor quantizes the input information to zero in a case where it is quantized to zero by quantization of the second quantization step, and the quantization processor performs quantization by the first quantization step in a case where it is quantized to non-zero by quantization of the second quantization step.

10. A variable-length coding method comprising:
obtaining quantization information by quantizing input information;
setting a single or plural kinds of parameters to quantize the input information;
calculating a generated code amount generated when the quantization information is variable-length coded;
calculating a quantization distortion amount of the quantization information;
calculating a coding cost from the quantization distortion amount and the generated code amount;
performing a control to change the parameter for quantization calculation to be set, calculating coding costs for the respective changed parameters for quantization calculation, selecting a parameter for quantization calculation corresponding to the minimum coding cost among the calculated coding costs; and
variable-length coding the quantization information quantized by using the selected parameter for quantization calculation.

11. A program product for realizing a variable-length coding method, the program product comprising instruction of:
obtaining quantization information by quantizing input information;
setting a single or plural kinds of parameters to quantize the input information;
calculating a code amount;
calculating a quantization distortion amount of the quantization information;
calculating a coding cost from the quantization distortion amount and the generated code amount;
performing a control to change the parameter for quantization calculation in the quantization calculation to be set, calculating coding costs for the respective changed parameters for quantization calculation, selecting a parameter for quantization calculation corresponding to the minimum coding cost among the calculated coding costs; and
variable-length coding the quantization information quantized by using the selected parameter for quantization calculation.

12. A moving image coding device for coding each image of a moving image, comprising:
a motion prediction processor to detect a motion vector of the inputted moving image;
a motion compensation processor to obtain a residual signal relative to the inputted image by performing motion compensation from the detected motion vector;
a transformation processor to transform the residual signal into a transformation coefficient;
a quantization processor to obtain quantization information by quantizing the transformed transformation coefficient;
a parameter setting processor to set a single or plural kinds of parameters to quantize;
a code amount calculation processor to calculate a code amount;
a quantization distortion calculation processor to calculate a quantization distortion amount of the quantization information;
a cost calculation processor to calculate a coding cost from the quantization distortion amount and the generated code amount;
a parameter search processor which controls the parameter setting processor to change the parameter for quantization calculation to be set, calculates coding costs by the cost calculation processor for the respective changed parameters for quantization calculation, and selects a parameter for quantization calculation corresponding to the minimum coding cost among the calculated coding costs; and
a variable-length coding processor to variable-length code the quantization information quantized by using the selected parameter for quantization calculation and the motion vector.
